(19) United States
(12) Patent Application Publication
(10) Pub. No.: US 2007/0070416 A1
(43) Pub. Date: Mar. 29, 2007

(54) Storage printer

(75) Inventor: Hiroaki Nakamura, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/584,501

(22) Filed: Oct. 23, 2006

Related U.S. Application Data
(63) Continuation of application No. 09/618,162, filed on Jul. 17, 2000.

(30) Foreign Application Priority Data
Jul. 16, 1999 (JP) 11-203253

(51) Int. Cl. G06F 3/12

(52) U.S. Cl. 358/1.15; 358/1.16

(57) ABSTRACT

The storage printer includes an image processing unit that analyzes an original image data acquired from an image data supply source to set image processing conditions and which processes the original image data in accordance with settings of the image processing conditions so as to produce outputting image data, a printing unit that makes a print using the outputting image data, a storage for storing a result of processing in the image processing unit and a reading unit that reads the result of processing from the storage and supplies it into either the image processing unit or the printing unit or both. In the storage printer, the pictures (or their image data) can be sorted and archived in a simple manner and reprints of the image which was previously printed can be easily made without receiving the image data again from a suitable image data supply source while bypassing personal computers and any other intervening equipment.

### BACKGROUND OF THE INVENTION

This invention relates to the technical field of storage printers in which image data for pictures taken with an imaging device such as a digital camera are typically used to output prints reproducing the pictures.

Presently in common use are imaging devices such as digital cameras and digital video cameras that utilize image readers such as CCD sensors. To make prints reproducing the pictures taken with such imaging devices, the image data for the picture is saved on a storage medium such as a smart media or a floppy disk, which is then set on a personal computer (PC) and the image data as read from the storage medium is used to yield a print with a printer connected to the PC.

Printers are commercially available today which are of such a type that the image data for pictures taken with imaging devices are directly read from storage media such as smart media and flash memory cards rather than via PC and subjected to image processing steps for optimization including contrast adjustment, lightness adjustment and color balance adjustment, with the optimized image data being used to yield prints.

Whichever of these conventional printing methods are employed, the pictures taken with imaging devices (or their image data) are usually sorted and archived in a predetermined storage area with the picture name, date of shooting and other necessary information being noted down on the recording media but this involves quite cumbersome procedures.

If a reprint of the image which was previously printed is to be made, you have to find out the storage medium containing the image to be reprinted and set it again on a PC or a printer. This also involves cumbersome procedures.

### SUMMARY OF THE INVENTION

The present invention has been accomplished under these circumstances and has as an object providing a storage printer for making prints that record pictures from various image data supply sources such as those taken with digital cameras or digital video cameras, characterized in that the pictures (or their image data) can be sorted and archived in a simple manner and that reprints of the image which was previously printed can be easily made without receiving the image data again from a suitable image data supply source while bypassing personal computers and any other intervening equipment.

In order to attain the object described above, the present invention provides a storage printer comprising an image processing unit that analyzes an original image data acquired from an image data supply source to set image processing conditions and which processes the original image data in accordance with settings of the image processing conditions so as to produce outputting image data, a printing unit that makes a print using the outputting image data, a storage for storing a result of processing in the image processing unit and a reading unit that reads the result of processing from the storage and supplies it into either the image processing unit or the printing unit or both.

Preferably, the result of processing in the image processing unit is at least one member of the group consisting of the outputting image data, a combination of the outputting image data and the original image data therefor, a combination of the outputting image data and the image processing conditions therefor, and a combination of the original image data and the image processing conditions thereof.

Preferably, the storage is a removable storage medium.

Preferably, the storage medium is at least one member of the group consisting of a digital video disk, a recordable compact disk, a semiconductor memory, a magneto-optical recording medium and a removable hard disk.

Preferably, the storage is externally connected thereto via a wire or radio waves.

It is preferable that the storage printer further comprises a transmission unit for supplying an external equipment with at least one member of the group consisting of the original image data, the outputting image data and the image processing conditions.

It is also preferable that the storage printer further comprises a display unit for displaying the outputting image data before the printing unit makes the print.

It is further preferable that the storage printer further comprises a search unit for searching for at least one member selected from the group consisting of the original image data, the outputting image data and the image processing conditions which are stored in the storage using a keyword.

Preferably, the result of processing in the image processing unit is an image file having tag information, the image file containing either the outputting image data or the original image data or both as image data, the image file being sorted and archived by reference to the tag information, and the search unit searching through the storage by referring to part or all of the tag information as the keyword.

Preferably, the result of processing in the image processing unit is an image file having tag information, the image file containing either the outputting image data or the original image data or both as image data, and the image file being sorted and archived by reference to the tag information.

Preferably, the tag information is an identification number marked on the print bearing a picture reproducing the outputting image data in the image file.

Preferably, the tag information is a character associated with the print bearing a picture reproducing the outputting image data in the image file.

### BRIEF DESCRIPTION OF THE DRAWING

FIG. 1 is a diagrammatic block diagram for an example of the storage printer of the invention.

### DETAILED DESCRIPTION OF THE INVENTION

The storage printer of the invention is hereunder described in detail with reference to the preferred embodiment shown in the accompanying drawing.

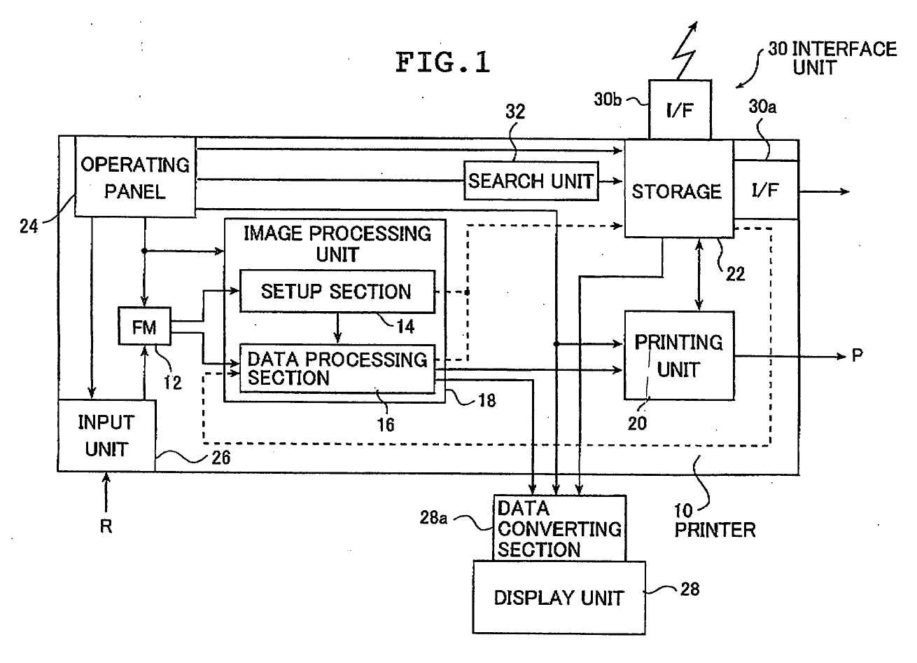

FIG. 1 is a diagrammatic block diagram for an example of the storage printer of the invention. The illustrated storage printer (hereunder simply referred to as “printer”) 10 receives original image data from an image data supply source R, performs specified image processing steps on the received image data to produce outputting image data, and outputs a print (hard copy) recording the picture of interest. The basic components of the printer 10 are a frame memory 12, an image processing unit 18 having a setup section 14 and a data processing section 16, a printing unit 20, a storage 22, an operating panel 24 and an input unit 26. As shown in FIG. 1, the printer 10 preferably includes a display unit 28, an interface (I/F) unit 30 and a search unit 32.

The image data supply source R to be used with the printer 10 of the invention is not limited to any particular type land various entities that can supply image data compatible with the printer 10 may be employed, as exemplified by imaging devices such as digital cameras and digital video cameras (and their built-in storage media), storage media such as smart media and flash memory cards that store various kinds of image data such as the image data for pictures taken with imaging devices, personal computers and communication device such as LANs (local area networks) and on-line networks. That is, preferable original image data is positive image data that was completed to a certain extent, including image data taken with a digital still camera.

In the case of the illustrated printer 10, a recording medium serving as the image data supply source R is loaded in the input unit 26 (its drive) and other kinds of image data supply source R such as an imaging device, communication device or a personal computer are connected to the input unit 26, so that the image data is transferred into the printer 10.

The image data acquired from the image data supply source R is sent from the input unit 26 to the frame memory (FM) 12, where it is stored and thence read into the image processing unit 18 having the setup section 14 and the data processing section 16.

The image data read from the frame memory 12 is subjected to specified image processing steps in the data processing section 16 so as to produce outputting image data suitable for image recording in the printing unit 20. While at least one image processing step is performed in the data processing section 16, the applicable steps are not limited to any particular kinds and may be exemplified by gray balance adjustment, color balance adjustment, chroma adjustment, gradation adjustment, density adjustment, electronic scaling (enlargement/contraction), sharpening, soft focusing, graininess suppression (noise reduction), reproduction of stored colors, dodging and conversion to image data compatible with the printing unit 20. These image processing steps may be implemented by suitable combinations of known techniques including mathematical operations (their algorithms), processing with an adder and a subtracter, processing with LUTs (look-up tables), operations with matrices (MTXs) and processing with filters.

The conditions for the image processing to be performed in the data processing section 16 (or the printing conditions) are set by the setup section 14 on the basis of image analysis. When image data are stored in the frame memory 12, the setup section 14 reads them and constructs density histograms and computes any necessary image characteristic quantities such as average densities, highlights (lowest densities), shadows (highest densities), and the densities at maximum and minimum values on histograms; then, in accordance with the density histograms, image characteristic quantities and inputs (e.g., color and density adjustments) entered from the operating panel 24, the setup section 14 computes the conditions for the various image processing steps to be performed in the data processing section 16 and sets the computed conditions in the data processing section 16.

The outputting image data obtained by processing in the data processing section 16 are supplied to the printing unit 20, which outputs a print recording an image reproducing the outputting image data. In the present invention, the printing unit 20 or unit for making prints P is not limited in any particular way and any known printing unit may be employed, hence various kinds of image recording apparatus can be adopted. Examples of the printing unit 20 include a printer that performs development after exposure by scanning a light-sensitive (and thermally developable) material with a laser beam, an electrophotographic printer, an ink-jet printer, a thermal head printer, a heated mode laser printer, and a heat transfer printer. The printing unit 20 may be adapted to have a back printing capability, or the ability to record a back print of various kinds of information on the back side of a print.

The storage printer 10 shown in FIG. 1 includes the display unit 28. In this particular case, the image reproducing the outputting image data is preferably shown on the display unit 28 before it is output as print P from the printer 20. If this is to be done, the outputting image data is converted to display image data by unit of a data converting section 28a in the display unit 28. The display devices that can be used as display unit 28 are not limited to any particular types and any known display devices can be used, as exemplified by a CRT display device and a liquid-crystal display device. The data converting section 28a is not the sole unit of performing conversion to the display image data with which the prepress image reproducing the outputting image data is shown on the display unit 28 and the data processing section 16 in the image processing unit 18 may be substituted.

Turning back to the printing unit 20 in the illustrated printer 10 of the invention, it sets information for accessing the outputting image data during the making of print P and records such access information on at least one side of the print P. According to another function of the printing unit 20, the image data (outputting image data) from which the print P has been made is supplied to the storage 22 as an image file having tag information such as access information. The storage 22 stores the image file in a location (address) predetermined in accordance with the access information and the date of shooting.

Thus, using the printer 10 of the invention, one can depend on the storage 22 for sorting and archiving once processed image data (outputting image data) such as the image for which the print P was previously made, thereby eliminating the existing cumbersome load of sorting and archiving storage media. If the once processed image is to be output as reprint P, all that is needed is to read the image data from the storage 22 into the printing unit 20 (or data processing section 16). Hence, there is no need to use storage media and other devices to store the image data and reprints can be made by simple and convenient procedures.

The storage 22 that can be used in the invention is not limited in any particular way and various known unit such as the built-in hard disk in the printer 10 may be employed; removable types of storage media are preferred as exemplified by a DVD (digital video disk), a CD-R (compact disk, recordable), various types of semiconductor memories, MO (magneto-optical recording media) and removable hard disks such as Zip.

The access information to be useful in the invention is not limited in any particular way, either, and may be exemplified by any suitable ID (identification) numbers, the date and time of print making, the name of the user, the name of the picture and any suitable characters [e.g., seasonal characters such as cherry blossom, snow and kagamimochi (a round mirror-shaped rice cake to be offered to a deity) and print classifying characters such as a mountain (landscape) and a human individual (portrait)]. These kinds of access information may optionally be used in combination. The user name, picture name, characters and like kinds of access information may be designated/input by manipulation of the operating panel 24 at a suitable time such as during print making. The characters are preferably but not necessarily associated with the print to be made and the user may choose any characters he or she prefers.

The access information may be set and the outputting image data converted into an image file format by means of the image processing unit 18 rather than by the printing unit 20. Alternatively, a site dedicated to these processes may be provided separately.

The invention is by no means limited to the case of recording the access information on the print P. Alternatively, when making a print of the picture for which the image data is stored in the storage 22, the operator may manipulate the operating panel 24 to enter access information such as the user name and characters so that the printer 10 selectively displays a list of candidate image files, from which the user can select the particular picture to be printed.

The image data (outputting image data) already processed in the data processing section 16 is not the sole example of what is to be stored as an image file in the storage 22 in the printer 10 of the invention. Other examples include the combination of the outputting image data with the image processing conditions, the combination of the original (yet to be processed) image data from the image data supply source R and the image processing conditions, and the combination of the outputting image data and the yet to be processed image data. Choices from these combinations may be further combined.

Thus, according to the invention, even in the absence of any data from the image data supply source R, there is no need to perform image analysis and, in a preferred case, the need for image processing can also be eliminated; all that is needed is that the data (information) capable of allowing the printing unit 20 to output a print P reproducing a processed picture should be stored in the storage 22 as the result of processing in the image processing unit 18. Needless to say, the access information described above is not the sole example of the tag information for the image file and various other kinds of information such as the size of the picture and the date of print making may of course be stored.

The outputting image data is stored as the image file in the storage 22. This is because the data can be used when an identically finished print is required as in reprinting thereby ensuring that the print obtained is identically finished. The original image data is also stored as the image file. This is because the image processing for printing varies with the intended purpose. Examples of the image processing include electronic scaling (enlargement/contraction), color adjustment, sharpening, frame composition, monotone finishing such as black-and-white finishing and sepia tone finishing. Depending on the image processing to be performed, for example in the case of monotone finishing, original color image signals are by no means restored. Therefore, the original image data need be stored.

If the image file, or the result of processing by the image processing unit 18, which is stored in the storage 22 is the combination of the original image data and the image processing conditions, they are read from the storage 22 into the data processing section 16 of the image processing unit 18 when the once processed image is to be output as reprint P and in accordance with the captured conditions, image processing is performed on the captured original image data so as to generate outputting image data and the generated outputting image data is output to the printing unit 20, thereby making the desired reprint P. In this case, too, there is no need for recording media to store the image data and yet a reprint of the once processed image can be made by simple and convenient procedures.

The storage printer 10 shown in FIG. 1 is a preferred embodiment of the invention, in which the storage 22 is equipped with an interface (I/F) unit 30 that comprises a wire telecommunication interface (I/F) 30a and a wireless telecommunication interface (I/F) 30b and which is externally connected to the storage printer 10 in a wired or wireless manner. If I/F 30a is wired to external equipment and I/F 30b connected to the same by radio waves, the results of image processing (image file) stored in the storage 22 as exemplified by the outputting image data, original image data and the image processing conditions can be transmitted to external equipment. In an alternative system design, the image file that is generated or possessed by external equipment and which contains the outputting image data, original image data, image processing conditions, etc. for the image that was once processed for print output may be received from the external equipment via I/F 30a and I/f 30b so that it can be saved in the storage 22. The external equipment may be any kind of printer that can produce print output and which is of the same or different kind from the storage printer of the invention. Alternatively, it may be a device such as a personal computer (PC) that can generate outputting image data or data for output from the printer.

In the preferred case of the invention which is shown in FIG. 1, the storage printer 10 has the search unit 32 so that even if no complete access or tag information can be acquired from the print P or none of such information can be obtained from the print P, part or all of such information or information that is associated with the print P is input as a keyword into the search unit 32 by manipulation of the operating panel 24, whereupon the search unit 32 looks through the storage 22 by referring to the input keyword and picks up the desired image file that has been saved in the storage 22, that matches with the keyword and which bears the necessary tag information. The advantage of this procedure is that even if no complete access or tag information can be acquired from the print P, the outputting image data for making a reprint of the picture on the print P in the printing unit 20, as well as the original image data and image processing conditions to be employed for reprinting purposes can be searched and picked up in an easy and rapid manner; as a result, reprints of the same image quality in terms of color and density reproduction can be yielded from the printing unit 20 in an easy and positive way.

Having described the basic configuration of the storage printer of the invention, we now describe its operation below in detail. We first discuss the case of making a print P of the original image data which has not been processed before. The user enters the necessary information from the operating panel 24 and the input unit 26 acquires the original image data and loads it into the frame memory 12. Then, the setup section 14 captures the original image data (a portion of which may optionally be “thrown out”) and constructs density histograms, as well as computing the image characteristic quantities in the manner already described above, thereby determining the image processing conditions (printing conditions) which are then set in the data processing section 16.

When the image processing conditions have been set, the data processing section 16 reads the original image data from the frame memory 12 and processes it in accordance with the settings of the processing conditions to generate outputting image data suitable for image recording with the printing unit 20 and the generated outputting image data is output to the printing unit 20.

If necessary, the outputting image data may be shown on the display unit 28 for prepress verification by the user. Thereafter, the printing unit 20 sets access information in the manner already described above and outputs a print P which records both the picture from the supplied outputting image data and the settings of access information. At the same time, the printing unit 20 supplies the storage 22 with the image data (outputting image data, original image data and image processing conditions) as an image file having tag information such as access information, and the storage 22 stores the image file at a predetermined address. If desired, the making of print P may be omitted to effect only supply/storage of the image file into the storage 22.

We next discuss the case of making a print P that records the image data already stored in the storage 22. If the storage 22 is a removable storage medium storing the image data (image file) from which to make a print P, it is loaded into a predetermined location (drive) in the printer 10 and then the operating panel 24 is typically manipulated to input access information and any other necessary information such as a command for making the print. If no access or tag information is obtainable or if only a part of them can be obtained, a keyword for looking up the print P is optionally set (the keyword is typically a portion of the access or tag information) and the search unit 32 searches through the storage 22 to pick up an image file that has matching with the keyword.

As a result, the printing unit 20 makes a print P by capturing from the storage 22 the outputting image data within the image file that has matching with the access information or which has been picked up by the search unit 32. Alternatively, the data processing section 16 captures the original image data and the image processing conditions in the image file and performs the necessary image processing to generate outputting image data and thereafter the printing unit 20 makes the print P. In this case, too, the image from the outputting image data may be displayed on the display unit 28 prior to printing. As already mentioned, any known wire or wireless telecommunication device may be used to ensure that the image data (image file) stored in the storage 22 can be transmitted via I/F 30 (30a, 30b) to external equipment in addition to the printing unit 20.

While the storage printer of the invention has been described above in detail, it is by no means limited to the foregoing embodiment and various improvements and modifications can of course be made without departing from the scope and spirit of the invention. In the illustrated case, the image data acquired from the image data supply source R is stored in the frame memory 12 before the image processing conditions are set and the predetermined image processing is performed. This is not the sole case of the invention and the image processing unit 18 may directly acquire the image data from the image data supply source R and perform various processing schemes on it. In another design modification, the storage printer of the invention may be adapted to have a capability for selecting between two modes during print making, one requiring the image data to be stored in the storage 22 and the other for “not required”.

As described above in detail, the storage printer of the invention provides ease in sorting and archiving the pictures (image data) taken with a digital camera or a digital video camera. As a further advantage, a once processed picture can be reprinted by a simple method without using storage media or a computer. The invention offers still another advantage in that reprints having the same image quality as the initial print or previous prints can be made in an easy and positive manner.

What is claimed is:

1. A storage printer comprising:
an image processing unit that analyzes an original image data acquired from an image data supply source to set image processing conditions and which processes said original image data in accordance with settings of the image processing conditions so as to produce outputting image data;
a printing unit that makes a print using said outputting image data;
a storage for storing a result of processing in said image processing unit; and
a reading unit that reads said result of processing from said storage and supplies it into either said image processing unit or said printing unit or both,
wherein said result of processing has access information for accessing said result of processing in said storage.

2. The storage printer according to claim 1, wherein said result of processing in said image processing unit is at least one member of the group consisting of said outputting image data, a combination of said outputting image data and the original image data therefor, a combination of said outputting image data and said image processing conditions therefor, and a combination of said original image data and said image processing conditions thereof.

3. The storage printer according to claim 1, wherein said storage is a removable storage medium.

4. The storage printer according to claim 3, wherein said storage medium is at least one member of the group consisting of a digital video disk, a recordable compact disk, a semiconductor memory, a magneto-optical recording medium and a removable hard disk.

5. The storage printer according to claim 1, wherein said storage is externally connected thereto via a wire or radio waves.

6. The storage printer according to claim 1, further comprising:
a transmission unit for supplying an external equipment with at least one member of the group consisting of said original image data, said outputting image data and said image processing conditions.

7. The storage printer according to claim 1, further comprising:
a display unit for displaying said outputting image data before said printing unit makes the print.

8. The storage printer according to claim 1, further comprising:
a search unit for searching for at least one member selected from the group consisting of said original image data, said outputting image data and said image processing conditions which are stored in said storage using a keyword.

9. The storage printer according to claim 8, wherein said result of processing in said image processing unit is an image file having tag information, said image file containing either said outputting image data or said original image data or both as image data, said image file being sorted and archived by reference to said tag information, and said search unit searching through said storage by referring to part or all of said tag information as the keyword.

10. The storage printer according to claim 1, wherein said result of processing in said image processing unit is an image file having tag information, said image file containing either said outputting image data or said original image data or both as image data, and said image file being sorted and archived by reference to said tag information.

11. The storage printer according to claim 10, wherein said tag information is an identification number marked on the print bearing a picture reproducing said outputting image data in said image file.

12. The storage printer according to claim 10, wherein said tag information is a character associated with the print bearing a picture reproducing said outputting image data in said image file.

13. A storage printer according to claim 1, wherein analyzing an original image data acquired from an image data supply source comprises:
reading the original image data;
constructing density histograms;
computing image characteristic quantities;
computing conditions for image processing steps to be performed in a data processing section of the image processing unit; and
setting the computed conditions in the data processing section.

14. A storage printer according to claim 13, wherein said image characteristic quantities comprise:
average densities, highlights, shadows and densities at maximum and minimum values on the histograms.

15. A storage printer according to claim 1, wherein the printing unit comprises:
back printing capabilities, wherein information is recorded on a back side of an image print.

16. A storage printer according to claim 1, wherein the storage stores an image file in a predetermined location address in accordance with access information and a date of shooting.

17. A storage printer according to claim 16, wherein said access information comprises identification numbers, date and time of print making, name of the user, name of the picture, and characters for classifying a print.

18. A storage printer according to claim 3, wherein said removable storage medium comprises a zip disk.

19. A storage printer according to claim 6, wherein said external equipment comprises a printer that can produce print output and is a same or different kind from the storage printer.

20. The storage printer according to claim 1, wherein said image data supply sources comprises one of:
a digital camera;
a digital video camera;
a local area network; and
an online network.

21. The storage printer according to claim 1, wherein said image processing unit, said printing unit, said storage, and said reading unit are housed in a common housing of said storage printer.
